(19) United States
(12) Patent Application Publication
(10) Pub. No.: US 2008/0091342 A1
(43) Pub. Date: Apr. 17, 2008

(54) System and method for ride matching

(76) Inventor: Jeffrey Assael, Woodland Hills, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/546,811

(22) Filed: Oct. 11, 2006

(51) Int. Cl. G01C 21/00

(52) U.S. Cl. 701/202

(57) ABSTRACT

Users are matched for ridesharing based on where they are from (origin), where they are going (destination), when they are traveling (time), and how often (frequency). Other commuting preferences may also be considered. Geographic matching is based on cross-streets rather than exact street addresses. Locations are geocoded for latitude and longitude. The other users stored in the database are matched with the user by comparing the user's data with the other user's data stored in a database. The user is presented with alias information regarding the matched users in the database for ridesharing. The order in which the matched users are presented may be weighed towards distance or time. Along with the alias information, ratings of these matched users can be displayed. The rating of a user is based on the past impressions of the rated user by other users.

### BACKGROUND OF THE INVENTION

The present invention relates to a system and method for ridesharing, and more specifically, to a computerized system for facilitating the matching of travelers with similar travel requirements.

Ridesharing is a traffic congestion management tool that includes carpools and other techniques for reducing commute trips, whether to work or school. A carpool is two or more commuters sharing a ride in one of their own vehicles. Carpools may be formed through an assortment of methods and are comprised of different groups of people. Carpools commonly are organized with family members, friends, neighbors, and/or co-workers.

Carpooling is often used to take advantage of traffic lanes dedicated to high-occupancy vehicles (HOVs) where multiple individuals share the same vehicle. Ridesharing has minimal incremental costs because it makes use of vehicle seats that would otherwise be unoccupied. Indeed, carpooling reduces the total number of commute trips made because each rideshare passenger, in addition to the driver, represents one less vehicle trip. Ridesharing may also have lower costs per vehicle-mile than public transportation because it does not require a paid driver and avoids empty backhauls.

In addition, ridesharing tends to experience economies of scale because as more people participate, the chances of finding a suitable carpool increases. Carpooling variations mirror the diversity of the participants: One person may drive all the time, while the passengers contribute only to the cost, such as gas and parking. In the alternative, participants may alternate driving, essentially bartering their driving services. Efficient sharing of vehicles can result in less traffic congestion, improved transit times, increased travel choices for commuters, reduced gasoline consumption, and cleaner air with less pollution.

Traditional ridesharing systems assume that the traveler has a fixed schedule and a fixed set of origins and destinations, which results in an inflexible commuting schedule. Another difficulty in ridesharing is lack of information regarding potential participants. Notices and information regarding traditional ridesharing systems were often posted on bulletin boards or shared through informal word-of-mouth social networks. However, such dissemination of information is inefficient. A potential rideshare participant may be unaware of another potential rideshare participant residing nearby, and therefore may not take advantage of potential rideshare efficiencies.

These problems have limited the usefulness and success of conventional ride sharing programs. Internet-based rideshare contact systems are known, but may lack sufficient privacy safeguards, may not effectively prioritize potential matches, and may provide insufficient information regarding potential rideshare participants. There exists a need for a system and method to provide the user with enough information to decide whether a match is acceptable and also enough information for contacting the match. There further exists a need to protect a user's privacy until he or she decides to send their contact information to another user who is a match.

### SUMMARY OF THE INVENTION

The present invention is a system and method for facilitating ridesharing among commuters. In a preferred embodiment of the invention, a person is matched with another person for ridesharing, and the results are shown in real or near real time based on where they are from, where they are going, when they are traveling and how often.

One embodiment of the present invention for matching users with similar travel requirements to facilitate ridesharing, includes the steps of receiving a start location SL for a user based on cross-streets, a destination location DL for the user based on cross-streets, a start time ST for the user; an arrival time AT for the user; and a commuting preference for the user. The frequency F of travel for the user may also be entered. The commuting preference may include gender preference, smoking preference, vehicle preference, and the preference to drive or ride. The received cross-streets for the start location SL and the destination location DL are converted to latitude and longitude values. The converted start location SL, converted destination DL, the start time ST, and the arrival time AT for the user is compared with corresponding data for other users stored in a database. The frequency F and the commuting preferences for the user may also be compared with the data of other users stored in the database. The other users stored in the database are matched based on these comparisons. The user is presented with a list of alias information regarding the matched users in the database, and the user may use the alias information to access desired matched users for ridesharing.

In one embodiment of the invention, the displayed list the other users may be presented in an order of priority that gives more weight to the difference in distance between the user and the other user, or gives more weight to the difference in time of travel between the user and the other user. The user can select whether to give more weight to distance or time of travel for priority listing. The order of priority may be determined using the following formula:

P=(ΔSL²+ΔDL²)+K(ΔST²+ΔAT²)

For this formula, P represents a priority ranking value; ΔSL represents the difference in distance between the starting location of the user and the starting location of a matched user in the database; ΔDL represents the difference in distance between the destination location of the user and the destination location of the matched user in the database; ΔST represents the difference in time between the starting time of the user and the starting time of the matched user in the database; ΔAT represents the difference in time between the arrival time of the user and the arrival time of the matched user in the database; and K represents a weighting factor. Locations may be given in units of miles, and times may be given in units of minutes. In one embodiment of the invention, where a matched user with a lower P value is listed before a matched user with a higher P value, a K value of greater than one would represent a greater weight towards distance, and a K value of less than one would represent a greater weight towards time.

In one embodiment of the invention, ratings for the matched rideshare participant are displayed with the alias information. The rating of a matched rideshare participant may be based on their past performance given by peers. These ratings can be based on satisfaction criteria such as the reliability, timeliness, and/or cleanliness of the rated rideshare participant.

In another embodiment of the invention, the start location SL of the user is compared to the start location SLᵢ₊₁ of another user stored in the database to determine whether the start location SLᵢ₊₁ of the other user is within a preselected distance from the start location SL of the user. In this embodiment of the invention, the default for the preselected distance is five percent of the total distance between the start location SL and the destination location DL of the user. A similar comparison may be performed between the destination location DL of the user and the destination location DLᵢ₊₁ of the other user stored in the database.

In one embodiment of the invention, a start city SC and a destination city DC for the user is entered. The start city SC for the user is compared with the start city SCᵢ₊₁ of other users stored in the database; and the matching of the other users stored in the database with the user is further based on this comparison of cities. A similar computation is performed for the destination city DC. Among other benefits, the destination city data serves to further confirm the appropriateness of a match for ridesharing.

In yet another embodiment of the invention, matched users are determined based on the start location SL without reference to the destination location in order to trigger matches to suggest a trip previously not thought of by the user, but that the user might want to take advantage of.

The features and advantages of the invention will be more readily understood from the following detailed description which should be read in conjunction with the accompanying drawings.

### BRIEF DESCRIPTION OF THE DRAWINGS

FIG. 1 is a schematic block diagram illustrating an embodiment of a ride matching system according to the present invention;

FIG. 2 is a flowchart illustrating the operation of an embodiment of a ride matching system according to the present invention;

FIGS. 3a and 3b are parts of a flowchart illustrating the matching operation of an embodiment of a ride matching system according to the present invention;

FIG. 4 is a diagrammatic representation of a screen display in accordance with an embodiment of the present invention;

FIG. 5 is a flowchart illustrating the operation of another embodiment of a ride matching system according to the present invention.

### DETAILED DESCRIPTION OF THE PREFERRED EMBODIMENTS

Referring now in more detail to the exemplary drawings for purposes of illustrating embodiments of the invention, wherein like reference numerals designate corresponding or like elements among the several views, the present invention now will be described more fully. Embodiments of the present invention described herein match a user with another user for a ridesharing trip to a destination. The invention may be embodied in many different forms and should not be construed as limited to the embodiments set forth herein.

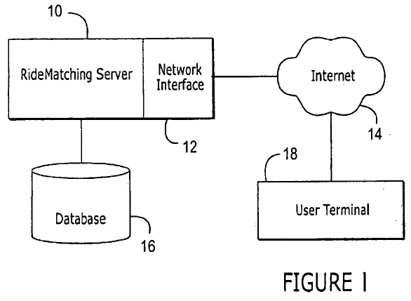

As illustrated in FIG. 1, ride matching server 10 is coupled through a network interface 12 to a network 14, such as the internet. The network 14 may include a plurality of separate linked physical communication networks, which, using a protocol such as the internet protocol (IP), may appear to be a single seamless communications network to user application programs. In addition, the network interface 12 may be a plurality of different interfaces coupled to different network types including wired and wireless networks. The network interface 12 may include an internet protocol interface to a digital communication network and/or a public switched telephone network (PSTN) interface. The network interface 12 may further include a wireless communication network interface configured to communicate with wireless terminals associated with registered users.

The ride matching server 10 is operatively coupled to a database 16 containing commute information for registered rideshare users. In the alternative, the database 16 may be accessed by the ride matching server 10 over the network 14 rather than being directly connected to the ride matching server 10. A relational database management system with multiple indexes may be used. A relational database management system typically presents data to the user in a tabular form, and provides relational operators to manipulate the data in tabular form. A user terminal 18 can access the ride matching server 10 via the network 14. The user terminal 18 may be a personal computer or a thin-client portal for internet access, and may include a wireless internet connection. Preferably, the server uses Active Server Pages (ASP) for dynamically-generated web pages, and Structured Query Language (SQL) to create, modify, retrieve and manipulate data from the database.

The ride matching server 10 is configured to identify potential rideshare candidates stored in the database 16 for a trip requested by a potential rideshare user based on the criteria received by the user. The criteria to be entered by the user at the user terminal 18 may include, but is not limited to, where the rideshare user is from (origin or start), where the rideshare user is going (destination), when the rideshare user is traveling (time), and how often (frequency). The geographic matching of start and destination locations are preferably determined on the basis of cross-streets rather than exact street addresses to enhance privacy while providing sufficient information to the user to determine whether a match is acceptable. These cross-street locations are preferably geocoded into latitude and longitude components.

Geocoding is a process that assigns a latitude-longitude coordinate to an address or other geographical information. Address geocoding involves matching addresses in a table to be geocoded to the street names and address ranges in the street network file. Geocoding software matches the street name in both the table to be geocoded and a reference table. After a latitude-longitude coordinate is assigned to the address by the geocoding process, the address can be displayed on a map or used in a spatial search, for example, in a Geographic Information System (GIS).

In one embodiment, a user at the user terminal 18 initially inputs information such as a start location SL in terms of cross-streets; a start city SC; a destination location DL in terms of cross-streets; and a destination city DC to the ride matching server 10. This information may be inputted before the user registers with the system. The information for the start city SC and destination city DC may include either city and state information, or zip code information. After entry of this initial information, the ride matching server 10 provides a visual display such as a map showing the start location SL and destination location DL. Preferably, the visual display map is centered on the screen of the user terminal 18 to show both the start location SL and the destination location DL. Preliminary matches based on the start location SL and destination location DL of other users stored in the database 16 are then made and marked on the map displayed at the user terminal 18. Preferably, the visual map is shown on the screen for the user terminal 18, and is also updated and refined each time the user enters a new selection criteria.

If the user is a prospective user who is not registered with the system, the prospective user will be prompted to input rideshare data at the user terminal 18. Before inputting the rideshare data, an exemplary map may be displayed to the prospective user as part of a tutorial or FAQ presentation. The exemplary map is a simulation to provide the prospective user with an example of how the match data is to be presented. For example, the exemplary map may present a pre-generated start location SL, destination location DL, and other pre-generated data.

The rideshare data requested of the prospective user may include the start location SL in terms of cross-streets, the start city SC (which may include the city and state, or just the zip code), the destination location DL in terms of cross-streets, and the destination city DC (which, again, may include the city and state, or just the zip code). A map showing potential matches is displayed to the prospective user, and may be refined and updated as the rideshare data is entered. As the prospective user inputs the start location SL and start city SC data at the input terminal 18, the ride matching server 10 will generate the map showing the start location. Preferably, the visual display of the map will be centered on the screen. As the prospective user inputs the destination location DL and destination city DC data at the input terminal 18, the ride matching server 10 will refine the map to show the start location and the destination location. Preferably, the map will be centered on the screen to visually display both the start location SL and the destination location DL.

In one embodiment, a map showing the start location and destination location, along with a list of potential matches, are generated to present to the prospective user on the display screen at the input terminal 18, so as to demonstrate the effectiveness of the system to the prospective user before registration. The top of the generated display screen preferably shows fields for the user to enter or change cross-street, and city (or Zip code) information for the start location SLᵢ, and fields for the user to enter or change cross-street, and city (or Zip code) information for the destination location DLᵢ. Preferably, the map and matches are updated each time a user enters new information or changes previously entered information. Start locations (SLᵢ and SLᵢ₊₁) may be matched within a radius of five percent of the distance between the start location SLᵢ and the destination location DLᵢ, as a default. Similarly, destination locations (DLᵢ and DLᵢ₊₁) may be matched within a radius of five percent of the distance between the start location SLᵢ and the destination location DLᵢ. Other percentages of the distance between locations may also be used. A list of matched users based on the selection criteria entered by the prospective user is also presented as part of the pre-registration display. Should the prospective user decide to register with the rideshare system, a “create account” or “log-in” screen may then be presented to the prospective user so that the prospective user may register for ridesharing services. For example, the prospective user may be prompted with a statement such as, “Free Log-in to Find Your Matches.”

Should the prospective user decide to register, the following additional information may be requested from the user:

1. User Handle (user name);

2. Email address;

3. Start Location radius, n in miles (show as optional, where default is 5% of the Start to Destination distance);

4. Destination Location radius, p in miles (shown as optional, where default is 5% of the Start to Destination distance);

5. Frequency of Travel, (1=one time trip, or 2=weekly commute);

6. Start Time, ST and time window, j (+/−j);

7. Arrival Time, AT and time window, k (+/−k);

8. Days of the week needed by user if Frequency=2 (for weekly commute);

9. Gender G is specified (“m” or “f”);

10. Gender Preference, GP of match (“m” for male, “f” for female, or “np” for no preference);

11. Smoking preference, S matches (specified by user, s for smoking, ns for nonsmoking, or np for no preference);

12. Any other special requests (such as no perfume);

13. Preference to drive or ride (d for drive, r for ride, or np for no preference);

14. Preference on vehicle (c for car, t for truck, v for van, d for no preference).

Entry of a “handle” or user name for the registered user, and an email address, allows the maintenance of privacy for the registered user on the rideshare system.

The database 16 contains information related to registered users, who may be identified as passengers, drivers or both. The database 16 may contain additional information in various embodiments of the present invention, such as personal factors and preferences of the rideshare candidates, and ratings of the rideshare candidates based on the past experiences of past rideshare users. This information is associated with the handle of the registered user. For example, start locations SLᵢ₊₁ and destination locations DLᵢ₊₁ may also be associated with the handles of registered rideshare users. The ride matching server 16 may be configured to identify a rideshare candidate based on information including, but not limited to, the start location SL (e.g., whether the distance between the user's start location and a rideshare candidate's start location is within a desired limit), destination location DL, start time ST for travel, arrival time AT, and frequency F of travel.

Preferably, all of the following criteria will be met for a match between the user and other user entries stored in the database:

1. Start Locations SL match within n miles.

2. Start City SC is the same.

3. Destination Location DL match is within p miles.

4. Destination City DC is the same.

5. Frequency of travel F is the same, where this denotes a one-time trip or a weekly commute.

6. Start Time ST matches within j minutes.

7. Arrival Time AT matches within k minutes.

8. Gender Preference GP matches the Gender of the other user, and Gender matches the Gender Preference of the other user.

9. Smoking preference S matches

10. Driving preferences match.

The map displayed to the user at terminal 18 is preferably refined and updated as new user information is entered into the system. As the map is being generated, the map may be refined to show Matches (or matched users) that meet the entered requirements for the now-registered user. These Matches are preferably represented by an alphanumeric marker on the map, and may be initially sorted by distance from the start location SL or the destination location DL, as selected by the user, and sorted closest to furthest. To reduce on-screen clutter on the map, the match information may be presented in a separate list below the map.

Different methods may be used to calculate distances between two locations. One way is to employ a street locator/distance software package which can calculate real driving distances.

Another method for calculating distances between two locations is to calculate as-the-crow-flies radial distances using the Pythagorean Theorem. However, calculating the distances using the square root of the sum of the squares of the differences in latitude and longitude can be very time consuming and may slow down the process.

A close approximation to using the Pythagorean approach would be to create a square box in latitude and longitude around the first user and find other users within that box. This is done for both the start and destination locations. This approach avoids the time-consuming calculations of the aforementioned Pythagorean Theorem method, and still provides sufficiently accurate distances for the matching process.

The list of matched users as potential rideshare candidates matching the user's criteria may be shown in a real or near real-time display on the screen of the user terminal 18 in an order of priority in which the difference in either the distance or the time is given more weight depending on the preference of the user. Preferably, the user is presented with alias information regarding the other users in the database who match for ridesharing. Along with the alias information, the rating of these other users by their peers may also be displayed. Preferably, the visual map shown on the screen for the user terminal 18 is updated and refined each time the user enters an additional selection criteria. The user is preferably provided with sufficient information to decide whether a match is acceptable, and with enough information for contacting the match such as by private messaging and/or a masked email system in order to further protect the privacy of the users until he or she decides to send their personal contact information to another user who is a match.

For each matched user presented, information regarding each match is provided to the now-registered user. This match information may include:

a. Frequency of travel for the matched user;

b. User handle of the matched user;

c. Matched user's cross street information;

d. Matched user's distances from Start location SL and Destination location DL;

e. Start and Arrival times for matched user;

f. Matched user's registration date or last sign-in on website;

g. Matched user's preference for driving or riding;

h. Matched user's smoking preference;

i. Days of the week a ride is needed by the matched user (if Frequency=2, for a regular weekly commute);

j. Any special requests match for each matched user (such as no perfume).

To reduce screen clutter, an on-screen button may be presented to the user to select the next set of Matches, or the previous set of Matches. Preferably, each set of Matches will include up to five matched users.

In one embodiment, clicking on any handle in the list of matched users brings up a Personal Message screen for the user to send a message to the selected matched user. The user sees the list again when the Personal Message is sent.

The following is an example of a message sent through a masked email system, where specific handles have been replaced by “[USER]” and “[MATCHED USER]”:

[USER], we have found a match for you! [MATCHED USER] is traveling from:

8^{th} Ave. & Butler Street, Pasadena, Calif. 91555

to

45^{th} & Main, West L.A., 92557

Leaving at 8:15 a.m and returning at 5:30 p.m.

Click HERE to see the map of your matching commute!

Click HERE to contact this member!

Using handles and a masked email system, the privacy of registered users on the rideshare system may be maintained.

The present invention will also be described in further detail with reference to flowchart illustrations according to a preferred embodiment of the invention. The flowchart diagrams illustrates the operation of an embodiment of the present invention that may be implemented by a computer program. Each block of the flowchart, and combinations of blocks in the flowchart, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the acts specified in the flowchart. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart.

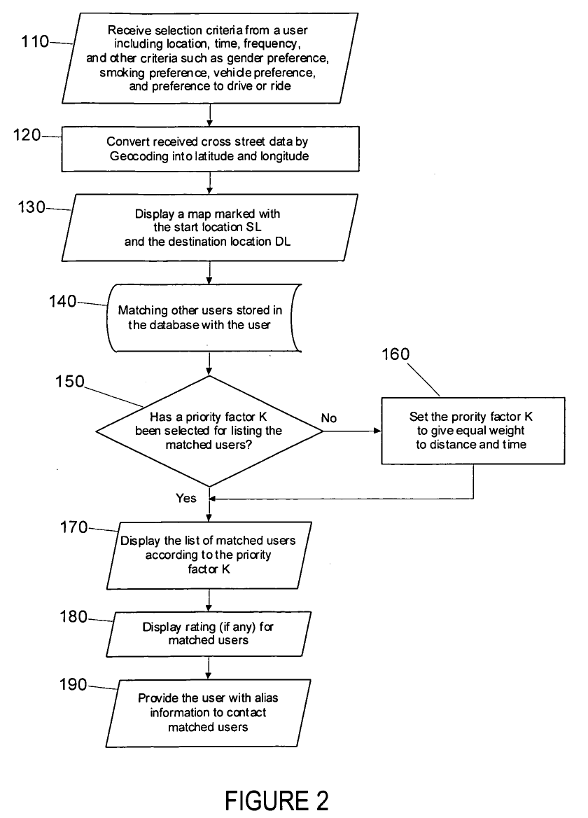

As illustrated by the overview flowchart of FIG. 2, operations for matching rideshare users may begin with block 110 where selection criteria is input by the user and received by the ride matching server. The selection criteria may include location, time, frequency, and other criteria such as gender preference, smoking preference, vehicle preference, and preference to drive or ride. The received cross street information for the start location SL and destination location DL is converted into latitude and longitude by geocoding, at block 120. At block 130, a map marked with the starting location SL and the destination location DL is displayed. The process of matching the user with other registered users stored in the database associated with the ride matching server is performed at block 140. If a priority weighting factor K has been selected by the user for listing the matched users, decision block 150 will prompt block 170 to display the list of matched users according to the selected priority weighting factor K. If a priority weighting factor K has not been selected by the user, then the priority weighting factor K is set at block 160 to give equal weight to distance (SL and DL) and time (ST and AT). At block 170, the list of matched users will be displayed according to the selected priority weighting factor K. If there is a peer rating associated with a matched user, then, at block 180, that rating is displayed for that matched user. The peer rating is preferably based on the past impressions of the matched user on other rideshare users in prior rideshare situations with the matched user. The rating may be in the form of a number (such as a number of stars). At block 190, the user is provided with alias information to contact matched users, such as through a masked email system.

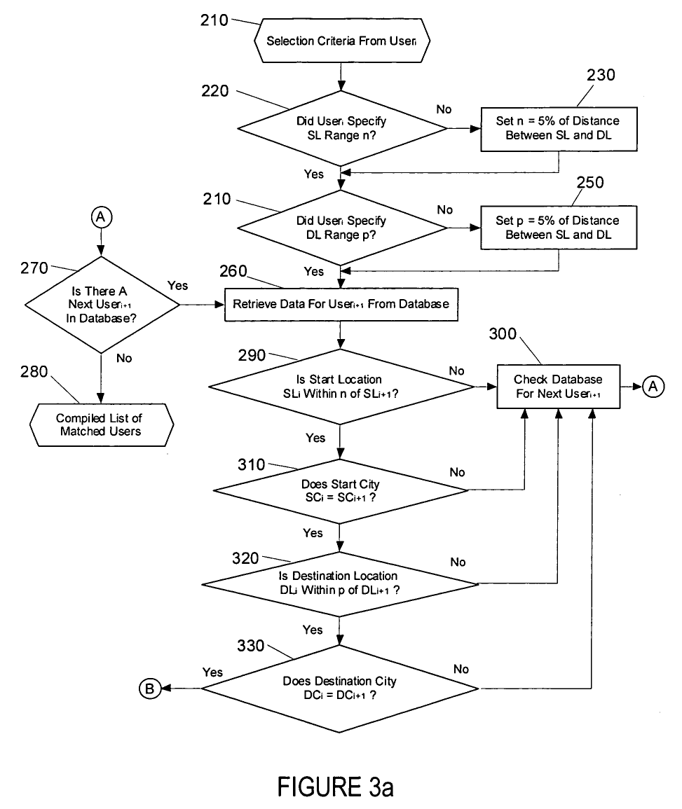

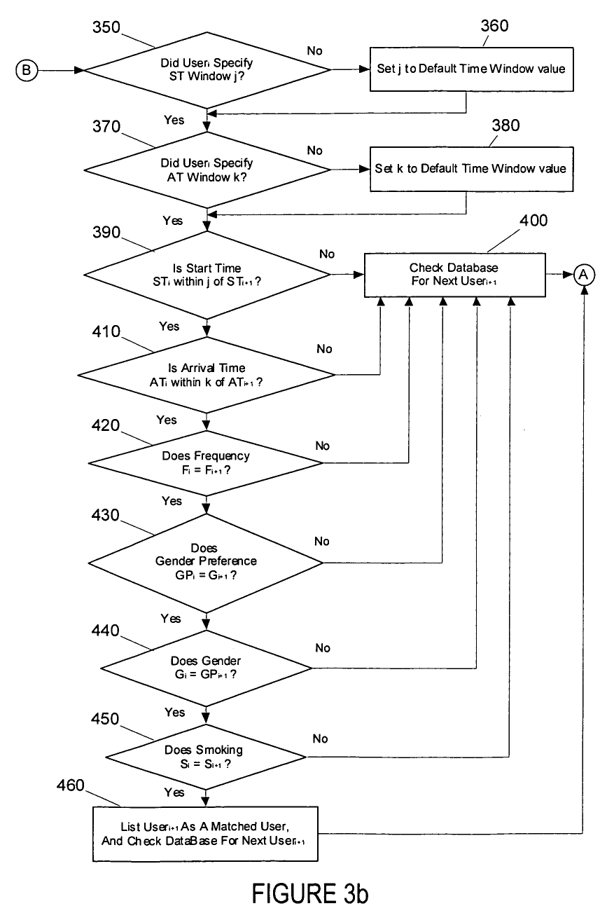

The flowchart of FIGS. 3a and 3b describes in further detail the user matching process of one embodiment of the invention, such as that represented by block 140 in FIG. 2. It is to be understood that it is not necessary to perform all of the steps in the exact order presented in the flowchart illustrated in FIGS. 3a and 3b. As noted at block 210, the process of matching other users stored in the database with a subject user is based on the selection criteria received from the user. The subject user may be designated or referred to as Userᵢ for convenience. The other users stored in the database may be designated or referred to generally as Userᵢ₊₁.

At block 220, if the Userᵢ did not specify a particular starting location SL range “n” as part of the selection criteria, then, at block 230, the starting location SL range “n” is set to be five percent of the distance between the starting location SL and the destination location DL range. Next, at block 240, if the Userᵢ did not specify a particular destination location DL range “p” as part of the selection criteria, then, at block 250, the destination location DL range “p” is set to be five percent of the distance between the starting location SL and the destination location DL range.

At block 260, the ride matching server 10 retrieves data (such as the rideshare selection criteria) stored in the database 16 for other users. At decision block 290, the server determines whether the start location SLᵢ₊₁ is within range “n” of start location SLᵢ. Preferably, the distances are calculated using the square-box-approximation method previously described. If the start location SLᵢ₊₁ of the Userᵢ is not within range “n” of start location SLᵢ, then the server 10 checks the database 16 for the next Userᵢ₊₁ at block 300. At decision block 270, if there is a next Userᵢ₊₁ in the database, then data for that next Userᵢ₊₁ is retrieved from the database, and the process is reiterated from block 260 onward. If there has been enough iterations such that there is no next Userᵢ₊₁ in the database, then the process moves to block 280 with a compiled list of matched users which will be presented to the Userᵢ at the user terminal 18.

If the server determines at decision block 290 that the start location SLᵢ₊₁ stored in the database is within range “n” of start location SLᵢ, then the process moves to block 310 to determine whether the start city SCᵢ of the Userᵢ matches the start city SCᵢ₊₁ of the Userᵢ₊₁ stored in the database. If no, then the server 10 goes back and checks the database 16 for the next Userᵢ₊₁ at block 300 to begin another iteration of the search for matching users. If the start city SCᵢ of the Userᵢ matches the start city SCᵢ₊₁ of the next Userᵢ₊₁ stored in the database, then the process moves to block 320 to determine whether the destination location DLᵢ₊₁ is within range “p” of destination location DLᵢ of the Userᵢ. If no, then the data for the next Userᵢ₊₁ is retrieved as previously discussed. If yes, then the process moves to decision block 330 to determine whether the destination city DCᵢ of the Userᵢ matches the destination city DCᵢ₊₁ of the Userᵢ₊₁ stored in the database. If no, then, as previously discussed, the data for the next Userᵢ₊₁ is retrieved.

If the determination at decision block 330 is that the destination cities match, then the process moves to decision block 350 as illustrated in FIG. 3b. If the Userᵢ did not specify a particular starting time window “j” as part of the selection criteria, then, at block 360, the starting time window “j” is set to a default time window value such as thirty minutes. Next, at block 370, if the Userᵢ did not specify a particular arrival time window “k” as part of the selection criteria, then, at block 380, the arrival time window “k” is set to the default time window value.

At decision block 390, the server determines whether the start time STᵢ of the Userᵢ is within time window “j” of start time STᵢ₊₁ of the Userᵢ₊₁ stored in the database. If the start time STᵢ₊₁ is not within time window “j” of start time STᵢ, then the server checks the database for the next Userᵢ₊₁ at block 400, which leads back to decision block 270. The iterative process proceeding from decision block 270 has already been discussed. If the start time STᵢ of the Userᵢ is within time window “j” of start time STᵢ, then the process moves to decision block 410 to determine whether arrival time ATᵢ₊₁ is within time window “k” of arrival time ATᵢ. If the determination at decision block 410 is negative, then the database is checked for the Userᵢ₊₁ stored in the database. If the determination at decision block 410 is affirmative, then the process moves to decision block 420 to determine whether the travel frequency Fᵢ criteria, if any, selected by the Userᵢ matches the travel frequency Fᵢ stored for the Userᵢ₊₁ in the database. If there is a match, then the process moves to decision block 430; otherwise the database is checked at block 400 to repeat the process for the next Userᵢ₊₁ stored the database. Selection criteria such as frequency F, gender preference GP, and smoking S, may take “no preference” values which would increase the probability of a match.

At decision block 430, the gender preference GPᵢ of the Userᵢ is compared with the gender Gᵢ₊₁ stored for the Userᵢ₊₁ to determine whether there is a match. Similarly, at decision block 440, the gender Gᵢ of the Userᵢ is compared with the gender preference GPᵢ₊₁ stored for the Userᵢ₊₁ to determine whether there is a match. The determination of a match for the smoking preference S is performed at decision block 450. If these decision blocks are affirmed, then the Userᵢ₊₁ is included as a matched user at block 460. The database is then checked for the next Userᵢ₊₁ to repeat the process until the entries for all users stored in the database are searched for matches.

Preferably, a linear search of the database is performed to find all stored users who meet the selected rideshare criteria. Equations summarizing this process are listed below (locations may be given in units of miles, and times may be given in units of minutes):

Standard equations to convert cross-streets to geocode latitude and longitude. 1.

SLᵢ>SLᵢ₊₁−n 2.

SLᵢ<SLᵢ₊₁+n 3.

SCᵢ=SCᵢ₊₁ 4.

DLᵢ>DLᵢ₊₁−p 5.

DLᵢ<DLᵢ₊₁+p 6.

DCᵢ=DCᵢ₊₁ 7.

STᵢ>STᵢ₊₁−j 8.

STᵢ<STᵢ₊₁+j 9.

ATᵢ>ATᵢ₊₁−k 10.

ATᵢ<ATᵢ₊₁+k 11.

DR=Default Radius=0.05*(Distance between SLᵢ and DLᵢ), used if n or p are not specified by the user 12.

Fᵢ=Fᵢ₊₁ 13.

GPᵢ=Gᵢ₊₁ 14.

Gᵢ=GPᵢ₊₁ 15.

Sᵢ=Sᵢ₊₁ 16.

P=(ΔSL²+ΔDL²)+K(ΔST²+ΔAT²) 17.

The order of priority for listing matched users may be determined by using the formula for priority ranking P, where weighting factor K can be used to weight the distance or the time differences more heavily. The weighting factor K may be assigned a value of one for a neutral weight). The values of “P” and “K” are without units. Here, P represents a priority ranking value; ΔSL represents the difference in distance between the starting location of the user and the starting location of a matched user in the database; ΔDL represents the difference in distance between the destination location of the user and the destination location of the matched user in the database; ΔST represents the difference in time between the starting time of the user and the starting time of the matched user in the database; ΔAT represents the difference in time between the arrival time of the user and the arrival time of the matched user in the database; and K represents a weighting factor. Where a matched user with a lower P value is listed before a matched user with a higher P value, a K value of greater than one would represent a greater weight towards distance, and a K value of less than one would represent a greater weight towards time. The user can select whether to give more weight to distance or time of travel for priority listing.

Prioritization should reflect how well the match meets the requirements and preferences of the user. Matched users who meet all the requirements will be shown at the top of the list. Matches that meet all but one of the requirements will show up in the next group on the list, and so on. Within any grouping, prioritization will be based upon the differences between the distances and times for the user and the matches. The closer the start points, the destination points and times, the closer the match will be and therefore, the higher the priority. This approach modifies the square root of the sum of the squares in that the square root function is not used so as to minimize calculation time and speed up the process. Prioritization (P) of matches results in a list where matches are sorted with those matched users with the smallest distance and time differences (smallest values of P) at the top of the list.

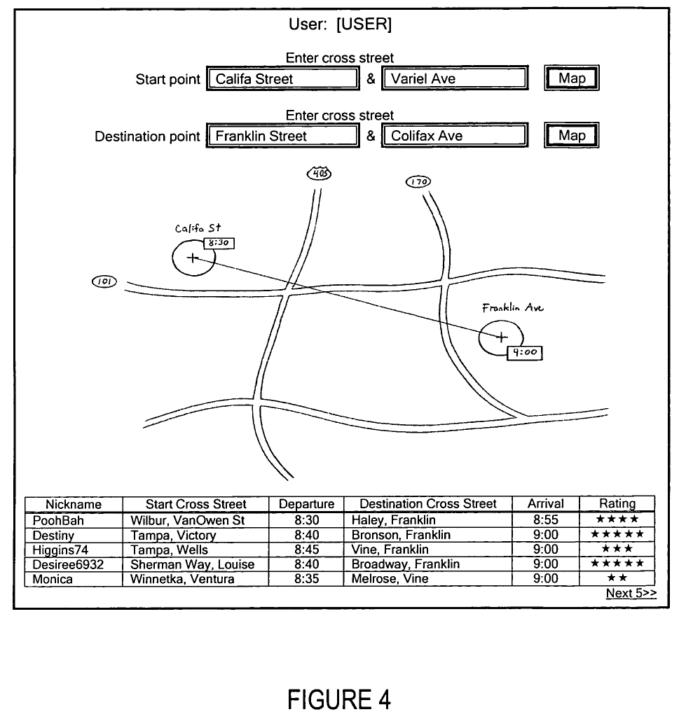

A diagrammatic representation of a screen display showing a map graphically illustrating a search radius along with a prioritized list of potential rideshare users from the database is illustrated in FIG. 4. The top of the screen display shows fields for the user to enter or change cross-street information for the start location SL and destination location DL. Fields may also be provided to enter or change city/state (and/or Zip code) information. The center of the screen display shows a map graphically illustrating the start location SL and the destination location DL. An on-screen button may be provided to prompt the system to update the map and matched user information. The bottom of the screen display shows, for example, a set of five matched users with corresponding rideshare information. As previously discussed, matches may be made within a default radius of five percent of the distance between the start location SL and the destination location DL, unless another percentage is selected by the user. An on-screen button allows the user to select, for example, the next set of five matched users, or the previous set of five matched users. Clicking on any user handle in the list of matched users may bring up a screen to allow the user to send a message to the selected matched user through a masked email system, or clicking may provide additional rideshare information and preferences for the matched user.

In one embodiment of the invention, the display for matching regular commutes is separate from the screen for matching one-time long-distance trips. The format of the display that is put on the screen may be determined by whether the inputted frequency of travel F denotes a one-time trip or a weekly commute.

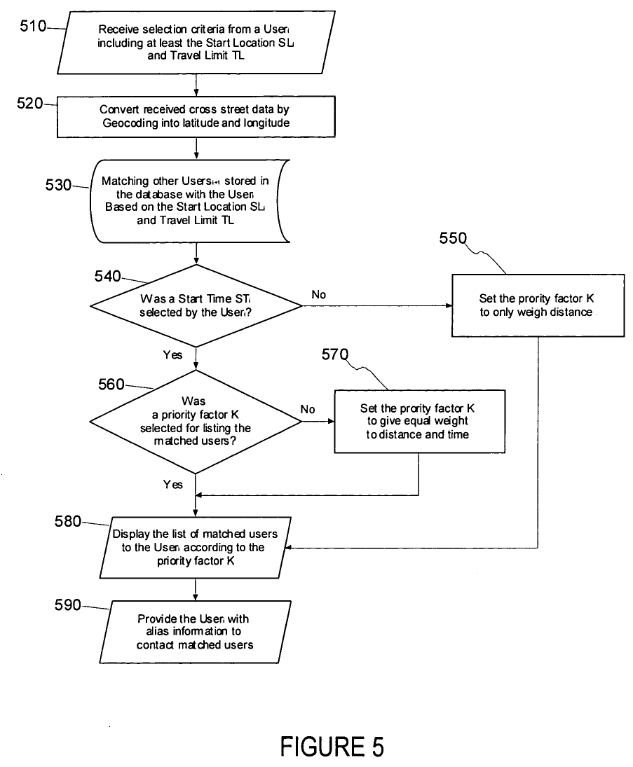

Another embodiment that searches for serendipitous one-time trip matches is illustrated in the flowchart of FIG. 5. Operations for matching users in this embodiment may begin with block 510 where selection criteria is input by the user (e.g., Userᵢ) and received by the ride matching server. The selection criteria in this embodiment preferably includes at least the start location SLᵢ and a travel limit TL, but not a specific destination location. The travel limit TL represents the distance of travel from the start location SLᵢ that the Userᵢ is willing to consider. The travel limit TL defines the radius from the start location SLᵢ to search for potential destination locations based on the destination locations DLᵢ₊₁ already entered by other Usersᵢ₊₁ stored in the database. Other criteria such as start time, start range, and start time window, may also be entered. The received cross street information for the start location SL is converted into latitude and longitude by geocoding, at block 520. The process of matching the Userᵢ with other registered Usersᵢ₊₁ stored in the database is performed at block 530. Preferably, the other registered Usersᵢ₊₁ stored in the database are matched to the Userᵢ based on the whether the start location SLᵢ₊₁ of a registered Userᵢ₊₁ is within a selected (or pre-selected) start range of the start location SLᵢ of the Userᵢ, and whether the destination location DLᵢ₊₁ of the registered Userᵢ₊₁ is within the travel limit TL selected by the Userᵢ. The default start range may be a percentage of the travel limit TL distance, such as five percent. The search may be refined with other criteria such as whether the start time is within a selected (or pre-selected) start time window.

If the Userᵢ selected a start time STᵢ for the trip, the process would move from decision block 540 to decision block 560. If a priority weighting factor K has been selected by the Userᵢ for listing the matched users, decision block 560 will prompt block 580 to display the list of matched users according to the selected priority weighting factor K. If a priority weighting factor K has not been selected by the user, then the priority weighting factor K is set at block 570 to give equal weight to distance and time in determining the order for listing matched users to be displayed at block 580.

If the Userᵢ did not select a start time STᵢ for the trip, the priority weighting factor K would be set at block 550 to only weigh distance in determining the order for listing matched users to be displayed at block 580. Preferably, a match with a destination location closer to the start location SLᵢ of the Userᵢ is given higher priority, or, conversely, a match with a destination location further from the start location SLᵢ of the Userᵢ is given higher priority. In the alternative, a match having a start location closer to the start location SLᵢ of the Userᵢ is given higher priority.

Allowing Userᵢ to search for matches based on the start location SL without a pre-selected destination location could potentially trigger a match previously not thought of by the user. Searching the system to determine which of the other registered Usersᵢ₊₁ are traveling to a destination location within a travel limit TL, representing a certain radius from a specific start location, may suggest a trip that the Userᵢ might want to take advantage of. These serendipitous one-time trip matches are displayed to the Userᵢ, and at block 590, the Userᵢ is provided with alias information to contact matched users, such as by masked email or other system to preserve privacy.

Ride matching systems according to various embodiments of the present invention may increase the usability of carpooling arrangements by making such arrangements more convenient and efficient through automated identification of potential rideshare users. While particular embodiments of the invention have been illustrated and described, it will also be apparent that various modifications can be made to what has been described without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

1. A method of matching users with similar travel requirements to facilitate ridesharing, comprising the steps of:
receiving a start location SL for a user based on cross-streets,
receiving a destination location DL for the user based on cross-streets,
receiving a start time ST for the user;
receiving an arrival time AT for the user;
receiving a listing preference for the user, wherein the listing preference indicates whether time or distance is a more important factor for the user;
converting the received cross-streets for the start location SL for the user and the destination location DL for the user to latitude and longitude values;
comparing the converted start location SL for the user with the converted start locations of other users stored in a database;
comparing the converted destination location DL for the user with the converted destination locations of other users stored in the database;
comparing the start time ST for the user with the start times of other users stored in the database;
comparing the arrival time AT for the user with the arrival times of other users stored in the database;
matching the other users stored in the database with the user based on the steps of comparing the start locations, comparing the destination locations, comparing the start times, and comparing the arrival times;
presenting the user with alias information regarding the matched users in the database, wherein the matched users are listed in an order of priority based upon the received listing preference, wherein more weight is given to distance when the received listing preference indicates distance as a more important factor for the user, and more weight is given to time when the received listing preference indicates time as a more important factor for the user;
providing the user with access to the matched users with the alias information.

2. The method of claim 1, wherein the order of priority is determined by the following formula:
P=(ΔSL²+ΔDL²)+K(ΔST²+ΔAT²)
wherein P represents a priority ranking value;
wherein ΔSL represents the difference in distance between the starting location of the user and the starting location of a matched user in the database;
wherein ΔDL represents the difference in distance between the destination location of the user and the destination location of the matched user in the database;
wherein ΔST represents the difference in time between the starting time of the user and the starting time of the matched user in the database;
wherein ΔAT represents the difference in time between the arrival time of the user and the arrival time of the matched user in the database;
wherein K represents a weighting factor for the listing preference.

3. The method of claim 2, wherein a matched user with a lower P value is listed before a matched user with a higher P value, and a K value of greater than one represents a greater weight towards distance, and a K value of less than one represents a greater weight towards time.

4. The method of claim 1, wherein the step of presenting includes the step of displaying a rating for the matched user, wherein the rating is based on feedback from a peer user based on the peer user's past impressions of the matched user.

5. The method of claim 1, wherein the step of comparing the start locations further comprises the steps of determining whether the start location SLᵢ₊₁ of another user stored in the database is within a selected distance from the start location SL of the user.

6. The method of claim 5, wherein the selected distance is five percent of the distance between the start location SL and the destination location DL.

7. The method of claim 1, further comprising:
receiving a commuting gender preference for the user;
comparing the commuting gender preference for the user with the gender of other users stored in the database; and
wherein the step of matching the other users stored in the database with the user is further based on the step of comparing the commuting gender preference for the user.

8. The method of claim 1, further comprising:
receiving a start city SC for the user;
receiving a destination city DC for the user;
comparing the start city SC for the user with the destination city of other users stored in the database; and
comparing the destination city DC for the user with the destination city of other users stored in the database; and
wherein the step of matching the other users stored in the database with the user is further based on the steps of comparing the start city and comparing the destination city.

9. The method of claim 1, further comprising:
receiving a frequency of travel F value for the user, wherein the frequency of travel F indicates whether the user is seeking a rideshare arrangement for a one-time trip or for a regular commute;
comparing the frequency of travel F for the user with the frequency of travel Fᵢ₊₁ of other users stored in the database;
wherein the step of matching the other users stored in the database with the user is further based on the step of comparing the frequency of travel.

10. A method of matching users with similar travel requirements to facilitate ridesharing, comprising the steps of:
receiving a start location SL for a user based on cross-streets,
receiving a destination location DL for the user based on cross-streets,
receiving a start time ST for the user;
receiving an arrival time AT for the user;
converting the received cross-streets for the start location SL for the user and the destination location DL for the user to latitude and longitude values;
comparing the converted start location SL for the user with the converted start locations of other users stored in a database;
comparing the converted destination location DL for the user with the converted destination locations of other users stored in the database;
comparing the start time ST for the user with the start times of other users stored in the database;
comparing the arrival time AT for the user with the arrival times of other users stored in the database;
matching the other users stored in the database with the user based on the steps of comparing the start locations, comparing the destination locations, comparing the start times, and comparing the arrival times;
presenting the user with alias information regarding the matched users in the database as a result from the step of matching, and ratings for the matched users, wherein the rating of the matched user is based on feedback from a peer user regarding the past performance of the matched user;
providing the user with access to the other users with the alias information.

11. The method of claim 10, further comprising the step of receiving a listing preference for the user, wherein the listing preference indicates whether time or distance is a more important factor for the user; wherein the matched users in the step of presenting the user with alias information, are listed in an order of priority based upon the received listing preference, wherein more weight is given to distance when the received listing preference indicates distance as a more important factor for the user, and more weight is given to time when the received listing preference indicates time as a more important factor for the user.

12. The method of claim 10, further comprising the step of receiving a listing preference from the user, and
wherein the step of presenting includes the step of listing the matched users in an order of priority based upon a received listing preference from the user, wherein the order of priority is determined by the following formula:
P=(ΔSL²+ΔDL²)+K(ΔST²+ΔAT²)
wherein P represents a priority ranking value, and a matched user with a lower P value is listed before a matched user with a higher P value;
wherein ΔSL represents the difference in distance between the starting location of the user and the starting location of a matched user in the database;
wherein ΔDL represents the difference in distance between the destination location of the user and the destination location of the matched user in the database;
wherein ΔST represents the difference in time between the starting time of the user and the starting time of the matched user in the database;
wherein ΔAT represents the difference in time between the arrival time of the user and the arrival time of the matched user in the database;
wherein K represents a weighting factor, wherein a K of greater than 1 more heavily weighs distance, and a K of less than 1 more heavily weighs time.

13. The method of claim 12, wherein a matched user with a lower P value is listed before a matched user with a higher P value, and a K value of greater than one represents a greater weight towards distance, and a K value of less than one represents a greater weight towards time.

14. The method of claim 10, wherein the step of comparing the destination locations further comprises the steps of determining whether the destination location DLᵢ₊₁ of another user stored in the database is within a selected distance from the destination location DL of the user.

15. The method of claim 14, wherein the selected distance is five percent of the distance between the start location SL and the destination location DL.

16. The method of claim 10, further comprising:
receiving a commuting gender preference for the user;
comparing the commuting gender preference for the user with the gender of other users stored in the database; and
wherein the step of matching the other users stored in the database with the user is further based on the step of comparing the commuting gender preference for the user.

17. The method of claim 10, further comprising:
receiving a start city SC for the user;
receiving a destination city DC for the user;
comparing the start city SC for the user with the destination city of other users stored in the database; and
comparing the destination city DC for the user with the destination city of other users stored in the database; and
wherein the step of matching the other users stored in the database with the user is further based on the steps of comparing the start city and comparing the destination city.

18. The method of claim 10, further comprising:
receiving a frequency of travel F value for the user, wherein the frequency of travel F indicates whether the user is seeking a rideshare arrangement for a one-time trip or for a regular commute;
comparing the frequency of travel F for the user with the frequency of travel Fᵢ₊₁ of other users stored in the database; and
wherein the step of matching the other users stored in the database with the user is further based on the step of comparing the frequency of travel.

19. A method of matching users with similar travel requirements to facilitate ridesharing, comprising the steps of:
receiving a start location SL for a user based on cross-streets,
receiving a travel limit TL for the user;
converting the received cross-streets for the start location SL for the user to latitude and longitude values;
comparing the converted start location SL for the user with the converted start locations of other users stored in a database;
determining whether the converted destination locations of other users stored in the database are within the distance defined by the travel limit TL;
matching the other users stored in the database with the user based on the steps of comparing and determining;
presenting the user with alias information regarding the matched users in the database;
providing the user with access to the matched users with the alias information.

20. The method of claim 19, wherein the step of comparing the converted start location SL for the user with the converted start locations of other users stored in a database, includes determining whether the converted start locations of other users stored in a database are within a selected distance of the converted start location SL for the user, wherein the selected distance is five percent of the travel limit TL.

21. The method of claim 19, further comprising the steps of:
receiving a start time ST for the user;
determining whether the start times of other users stored in the database are within a time window of the start time ST for the user;
wherein the step of matching is further based on the step of determining whether the start times of other users stored in the database are within the time window.

22. The method of claim 21, further comprising the steps of:
receiving a listing preference for the user, wherein the listing preference indicates whether time or distance is a more important factor for the user;
wherein the matched users are listed in an order of priority based upon the received listing preference, wherein more weight is given to distance when the received listing preference indicates distance as a more important factor for the user, and more weight is given to time when the received listing preference indicates time as a more important factor for the user.
